(19) United States
(12) Patent Application Publication
(10) Pub. No.: US 2002/0087433 A1
(43) Pub. Date: Jul. 4, 2002

(54) Business system for producing/selling original cards or posters using multimedia terminal installed in chain store

(76) Inventor: Yuko Fujinami, Tokyo (JP)

Correspondence Address: YUKO FUJINAMI, 104, WAKAMATSUCHO 36-25, SHINJUKU-KU, TOKYO, 162-0056, JP

(21) Appl. No.: 09/752,963

(22) Filed: Dec. 28, 2000

(51) Int. Cl. G06F 17/60; G06F 17/00; G06F 7/00

(52) U.S. Cl. 705/27; 707/104.1

(57) ABSTRACT

To provide a system that allows a general user to easily use a multimedia terminal to form information ranging from past one to the current one into cards or posters or save or collect the information.

A business system for producing/selling original cards or posters using a multimedia terminal installed in each chain store, each chain store having a multimedia terminal (hereafter referred to as a “terminal”) installed therein and operated by a user to produce or sell original cards or posters, the terminal comprising a communication function and a printing function and being used to access a database provided beforehand and specialized for a particular field, via the Internet or a communication system to retrieve information so that the user can convert it into characters or videos to produce or sell original individualistic cards or posters, data for the particular field including those for various sports such as horse racing, baseball, basket ball, foot ball, and car races, characters, cooking, or talents such as movie stars, for example, the system being characterized in that:

the terminal is installed in a chain store such as a convenience store, a fast food shop, a drug store, a supermarket, or station kiosk which has a network, the user operates the terminal to retrieve desired or intended information from the database and appropriately arrange it to produce original cards or posters, the user can arbitrarily adjust sizes of the cards or posters, the user can also add messages such as the user's pictures or characters to the data retrieved from the database, the user can further retrieve past data and data of the day to compare their contents or can print both data in a single card or poster, the user can inform people of a result or situation of a horse race, a different type of race, or a sport event that has taken place on that day, earlier than general media, and can produce cards or posters containing such information, and if this system is used to transmit live videos of a sport event or a different type of event to the database and the terminal is then used, the live videos or characters can be printed on cards or posters to produce original advertisements, presents, or souvenirs.

### BACKGROUND OF THE INVENTION

The present invention relates to a system wherein a multimedia terminal is installed in a chain store so that a user can operate the terminal to produce or sell original cards or posters.

Multimedia terminals are conventionally used to receive unilaterally transmitted information.

This has the following disadvantages:

a. Users cannot opt to limit transmitted information to their desired information

b. Users cannot incorporate their messages or ideas in transmitted information.

c. Users can obtain information only from general media; that is, they cannot obtain information promptly.

d. Users cannot arrange or configure transmitted information.

e. The terminal is used only to receive and transmit information; that is, its usage is limited.

The present invention eliminates these disadvantages and enables a multimedia terminal to be used for many applications other than a function for simply transmitting and receiving information.

### SUMMARY OF THE INVENTION

A business system for producing/selling original cards or posters using a multimedia terminal installed in each chain store, each chain store having a multimedia terminal (hereafter referred to as a “terminal”) installed therein and operated by a user to produce or sell original cards or posters, the terminal comprising a communication function and a printing function and being used to access a database provided beforehand and specialized for a particular field, via the Internet or a communication system to retrieve information so that the user can convert it into characters or videos to produce or sell original individualistic cards or posters, data for the particular field including those for various sports such as horse racing, baseball, basket ball, foot ball, and car races, characters, cooking, or talents such as movie stars, for example, the system being characterized in that:

the terminal is installed in a chain store such as a convenience store, a fast food shop, a drug store, a supermarket, or station kiosk which has a network, the user operates the terminal to retrieve desired or intended information from the database and appropriately arrange it to produce original cards or posters, the user can arbitrarily adjust sizes of the cards or posters, the user can also add messages such as the user's pictures or characters to the data retrieved from the database, the user can further retrieve past data and data of the day to compare their contents or can print both data in a single card or poster, the user can inform people of a result or situation of a horse race, a different type of race, or a sport event that has taken place on that day, earlier than general media, and can produce cards or posters containing such information, and if this system is used to transmit live videos of a sport event or a different type of event to the database and the terminal is then used, the live videos or characters can be printed on cards or posters to produce original advertisements, presents, or souvenirs.

### DETAILED DESCRIPTION OF THE INVENTION

An embodiment of the present invention will be described below.

a. A multimedia terminal (hereafter referred to as a “terminal”) is installed in a chain store such as a convenience store, a drug store, a supermarket, or a fast food shop.

b. The terminal comprises a communication and a printing functions.

c. A system is constructed in which a user can access a database from the terminal via the Internet or a communication system.

d. A database for a particular field is prepared beforehand. The database consists of information ranging from past one to the current one.

e. The database contains:

information such as results or photographs of or dividends at a horse race, a car race, or the like which has taken place on that day;

prompt reports on results of sport events such as baseball, basket ball, and foot ball which have taken place on that day;

Images or profiles of or data on characters contracting with authors;

photographs or recipes of various dishes or data on calories or nutritive values;

photographs or profiles of or data or news on movie or TV starts; or information such as vides of or characters for sightseeing spots all over the world.

f. A user or a store clerk operates the terminal to print videos or characters from the database to produce card or posters. The user can insert his or her designed characters or pictures into the cards or posters.

g. Once the arrangement of information for the cards or posters, a design to be inserted, or the size thereof have been determined, the user prints out the cards or posters.

h. The user sells the printed-out cards or posters or uses them to advertise an event or produce calendars or stars'pictures.

Whenever a user visits a chain store where a multimedia terminal (hereafter referred to as a “terminal”) is installed, he or she can obtain information ranging from past one to the current one. This information can be used to produce cards or posters and configure or sell what are worth original or promptly-reporting newspapers or magazines. Additionally, if the user desires to collect information for a particular field, he or she can print out the information from the terminal and save it for collection.

By providing a database unique to a chain store with the terminal installed therein, the store can produce cards or posters that can be purchased only by visitors. This serves to increase the number of repeaters and thus the sales of the chain store.

What is claimed is:

1. A business system for producing/selling original cards or posters using a multimedia terminal installed in each chain store, each chain store having a multimedia terminal (hereafter referred to as a “terminal”) installed therein and operated by a user to produce or sell original cards or posters, the terminal comprising a communication function and a printing function and being used to access a database provided beforehand and specialized for a particular field, via the Internet or a communication system to retrieve information so that the user can convert it into characters or videos to produce or sell original individualistic cards or posters, data for the particular field including those for various sports such as horse racing, baseball, basket ball, foot ball, and car races, characters, cooking, or talents such as movie stars, for example, the system being characterized in that:
the terminal is installed in a chain store such as a convenience store, a fast food shop, a drug store, a supermarket, or station kiosk which has a network, the user operates the terminal to retrieve desired or intended information from the database and appropriately arrange it to produce original cards or posters, the user can arbitrarily adjust sizes of the cards or posters, the user can also add messages such as the user's pictures or characters to the data retrieved from the database, the user can further retrieve past data and data of the day to compare their contents or can print both data in a single card or poster, the user can inform people of a result or situation of a horse race, a different type of race, or a sport event that has taken place on that day, earlier than general media, and can produce cards or posters coantaining such information, and if this system is used to transmit live videos of a sport event or a different type of event to the database and the terminal is then used, the live videos or characters can be printed on cards or posters to produce original advertisements, presents, or souvenirs.
